(19) United States
(12) Patent Application Publication
(10) Pub. No.: US 2007/0089337 A1
(43) Pub. Date: Apr. 26, 2007

(54) Display assembly

(76) Inventor: Mark Hans Van Kehrberg, China, MI (US)

Correspondence Address: LAW OFFICES OF JOHN CHUPA & ASSOCIATES, P.C., 28535 ORCHARD LAKE ROAD, SUITE 50, FARMINGTON HILLS, MI, 48334, US

(21) Appl. No.: 11/256,868

(22) Filed: Oct. 24, 2005

(51) Int. Cl. G09F 21/04

(52) U.S. Cl. 40/591

(57) ABSTRACT

An information dissemination assembly 10 which may be selectively and removably deployed upon a selectively movable assembly, such as a vehicle 92, thereby allowing information 50, 52 to be displayed to a wide variety of people as the selectively movable assembly, such as vehicle 92, is driven or moved within an environment.

### FIELD OF THE INVENTION

This application claims the benefit of priority of Prior U.S. Provisional Patent Application 60/594,693, which was filed on Apr. 28, 2005. The present invention generally relates to a display assembly and more particularly to a display assembly which is adapted to be selectively and removably secured to a selectively movable assembly and which allows various types of information to be displayed upon the selectively movable assembly.

### BACKGROUND OF THE INVENTION

With the great proliferation of products and services, it has become increasingly important to create various forms and types of advertisements in order to properly inform the general public about these various products and service.

One approach to providing such advertisements is to create certain information about the desired products and services and place the created information upon a stationary billboard. While this approach does selectively inform those in close proximity to the stationary billboard about some of these goods and services, it fails to provide the necessary information dissemination to those who are not in such close proximity. Further, it has traditionally been very difficult and costly to change or otherwise modify this billboard type of information.

To alleviate some or all of these drawbacks, a second advertising strategy requires the creation of tangible information which is mailed to certain members of the public or placed in an intangible format and electronically mailed to various Internet users. While the foregoing two approaches do allow advertisement information to be selectively disseminated, they suffer from various drawbacks. For example and without limitation, the first of these approaches is costly and both approaches are typically ignored by many people who find them to be distasteful and often refer to. these products as “junkmail” or “spam”. In fact, there exist many “spam type filters” which are adapted to prevent this “spam” from even reaching the intended recipients.

There is therefore a need for a new and improved advertisement and information dissemination strategy which overcomes some or all of the previously delineated disadvantages of prior advertisement and information dissemination strategies.

### SUMMARY OF THE INVENTION

It is a first non-limiting object of the present invention to provide a display assembly which overcomes some or all of the previously delineated drawbacks of prior advertisement and information dissemination strategies, some of which have been delineated above.

It is a second non-limiting object of the present invention to provide a display assembly which allows information to be selectively placed upon a selectively movable assembly, such as a vehicle, in a cost effective and easily changeable manner.

According to a first non-limiting aspect of the present invention, a sign assembly is provided and includes a sign retention portion; and a hitch reception portion is provided.

According to a second non-limiting aspect of the present invention, an advertising assembly is provided and includes a first broad planar portion having a substantially C-shaped cross sectional area of a certain width and a certain height and a second channel portion which orthogonally extends from their first broad planar portion and which includes a through hole having an axis of symmetry which is substantially parallel to the first broad planar portion; a sign which has a height which is slightly smaller than the certain height and a width which is slightly shorter than the certain width and which is adapted to selectively and frictionally fit upon the first broad planar portion; and a pin which is selectively and removably received within the through hole.

According to a third non-limiting aspect of the present invention, an advertising assembly is provided and includes a support portion having a broad planar sign reception surface having a pair of opposed edges which respectively border the broad planar sign reception portion and are respectively and linearly coextensive to the broad planar sign reception portion, wherein the support portion includes a hitch reception portion which orthogonally emanates from the planar sign reception portion and which has a slightly smaller width than the width of a trailer hitch and which further includes a through hole of a certain diameter; a first pin which has a diameter which is slightly smaller than the certain diameter; and a second C-shaped member which includes a support width which is only slightly larger than the distance between the pair of opposed edges; and a flat member which has a width which is slightly smaller than the distance between the pair of opposed edges.

These and other features, aspects, and advantages of the present invention will become apparent from a reading of the detailed description of the preferred embodiment of the invention, including the subjoined claims and by reference to the following brief description of the drawings.

### BRIEF DESCRIPTION OF THE DRAWINGS

FIG. 1 is a perspective view of the display assembly of the preferred embodiment of the invention in assembled combination with a portion of a selectively movable assembly, such as and without limitation a vehicle.

FIG. 2 is a side view of the display assembly which is shown in FIG. 1.

FIG. 3 is a perspective view of a display assembly which is made in accordance with the teachings of an alternate embodiment of the invention in assembled combination with a portion of a selectively movable assembly, such as and without limitation a vehicle.

FIG. 4 is a perspective back view of the display assembly which is shown in FIG. 1.

FIG. 5 is perspective assembled view of the display assembly which is shown in FIG. 1 in combination with a vehicle.

FIG. 6 is a perspective view of a portion of the display assembly which is made in accordance with the teachings of a third embodiment of the invention.

FIG. 7 is a front view of an informational display portion which is used by the various embodiments of the invention.

### DETAILED DESCRIPTION OF THE PREFERRED EMBODIMENT OF THE INVENTION

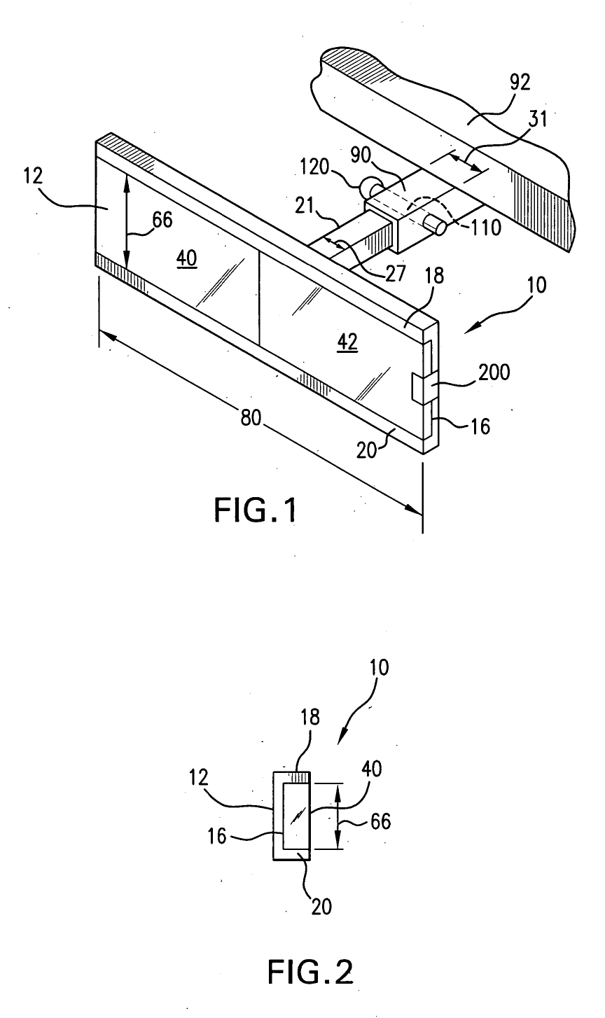

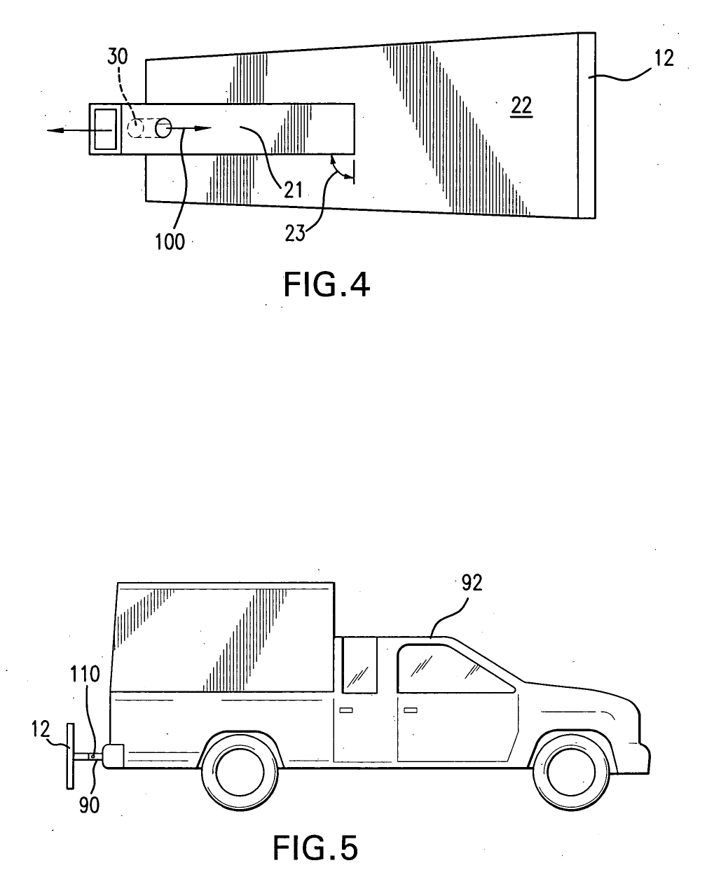

Referring now to FIGS. 1, 2 and 4, there is shown a sign or information dissemination assembly 10 which is made in accordance with the teachings of the preferred embodiment of the invention.

Particularly, the assembly 10 includes a sign or information disseminating member support portion 12 which has a substantially “C-shaped” cross sectional area and which includes a generally planar support surface 16. The portion 12 may be formed from steel or some other commercially available material, such as plastic or some composite material.

Further, as shown, the portion 12 includes a pair of opposed and substantially identical protruding edges 18, 20 which, in one non-limiting embodiment, are linearly coextensive to the broad planar support surface 16 and the portion includes a hitch reception portion 21 which, in one non-limiting embodiment, orthogonally emanates from the back surface 22 of the portion 12 (e.g., the portion 21 makes a right angle 23 with the surface 22). Particularly, in one non-limiting embodiment, the surface 22 is generally planar and is opposite to the surface 16 and the hitch reception portion 21 is integrally formed with and integrally protrudes from the surface 22.

In the most preferred embodiment of the invention, the portion 21 includes a through hole 30 having a certain diameter and being positioned toward the end of the portion 21 which is distal from the surface 22 (i.e., toward the end which is opposite to the end of the portion 21 which is connected to or which is integrally formed with the surface 22).

As shown best perhaps in FIGS. 1 and 7, the assembly 10 also includes a pair of substantially identical signs or information containing members 40, 42. In the most preferred embodiment of the invention, each of the information containment members 40, 42 is generally transparent and may be made of plastic or commercially available plexiglas™ type material. In this manner, advertising or other sorts of information 50, 52 may be respectively placed upon the respective surfaces 54, 56 of members 40, 42 by writing or by adhering some sort of information banner or other sign to the respective surfaces 54, 56 and thereby being susceptible to being easily removed and changed at will. The respective information 50, 52 may comprises substantially any sort of desired type of information and, in another non-limiting embodiment, may even be written on the surfaces 40, 42 by use of erasable or permanent type ink material.

Each of the information containing members or “signs” 40, 42 has a respective and substantially identical height 60, 62 which is only slightly smaller than the substantially constant height 66 between the edges 18, 20. Further, each of the members 40, 42 respectively includes a substantially identical width 70, 72 which is respectively equal to about one half of the width 80 of the member 12.

In this manner, it should be apparent and as is perhaps best shown in FIGS. 1 and 2, that each of the members 40, 42 may reside upon the surface 16 and frictionally fit between the edges 18, 20 with the respective information containing surfaces 54, 56 outwardly extending from the surface 16, thereby allowing the respective information 50, 52 to be read and discerned by those in close proximity to the assembly 10 and to the selectively movable assembly upon which the assembly 10 is selectively deployed.

As shown best perhaps in FIGS. 1 and 5, the portion 21 may be selectively inserted into a conventional trailer hitch 90 of a selectively movable assembly, such as vehicle 92. That is, the width 27 of the portion 21 is slightly smaller than the width 31 of the trailer hitch 90, thereby allowing the portion 21 to be selectively, removably, and frictionally inserted within the portion 90. Particularly, the through hole 30 which includes a longitudinal axis of symmetry 100 which is parallel to surfaces 20 and 22 is aligned with the through hole 110 of the trailer hitch 90, thereby allowing a pin 120 to be selectively inserted through the registered through holes 30 and 110 and thereby being effective to hold the assembly 10 within the trailer hitch 90 as the selectively movable assembly 92 is operated (e.g. is moved). If the pin 120 is removed, the portion 21 may be readily removed from the hitch 90. It should be appreciated that substantially any sort of commercially available pin 110 may be utilized.

In this manner, the movement of the assembly 92 allows the information 50, 52 to moved “around” an environment and a populace in order to increase the number of people who will view the information 50, 52 and while concomitantly allowing the selectively movable assembly 92 to perform some other useful function. Hence, the information 50, 52 is disseminated in a very cost effective manner and may be easily changed and modified.

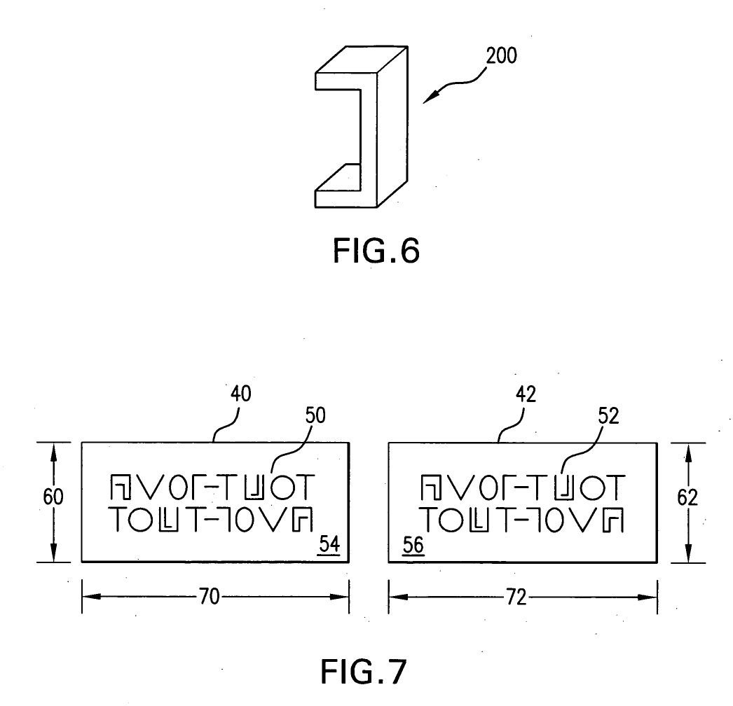

In one non-limiting embodiment of the invention, a “C” shaped and flexible clasp member 200, as shown best in FIGS. 1 and 6, may selectively and frictionally receive member 42 and surface 22, thereby ensuring that member 42 will not move away from its operative position on the surface 16. A second similar member may frictionally engage the surface 22 and the member 40, further ensuring that the member 40 remains operatively positioned upon the surface 16, The members 200 may be flexed and removed from such engagement, thereby allowing the members 40, 42 to be removed from the surface 16 (e.g., to service them, replace them, and/or modify them).

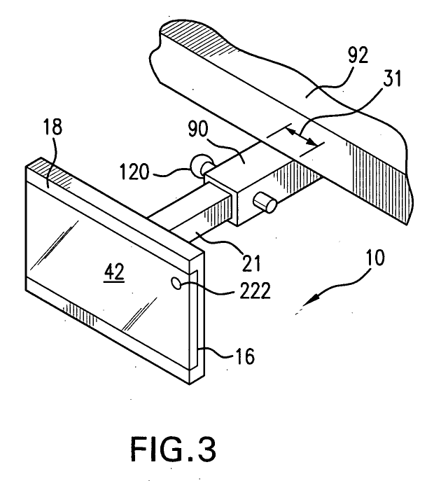

In yet another non-limiting embodiment of the invention, as shown best in FIG. 3, the surface 16 may be modified to substantially any desired size and shape, including one half of the size shown in FIG. 1 (e.g., enough to support only member 42). Further, as best shown in FIG. 3, a removable pin 222 may be used to respectively secure the member 42 to the surface 16. Such a pin 222 may also be used, in the embodiment of FIG. 1, to secure the members 40, 42 to the surface 16.

It is to be understood that the various inventions are not limited by the specific embodiments which are delineated above, but that various changes and modifications may be made without departing from the spirit and the scope of the inventions as are more fully delineated in the following claims. It should be appreciated that assembly 10 may be used with substantially any selectively movable assembly and is not limited to a vehicle.

What is claimed is:

1) A display assembly comprising a sign retention portion; and a hitch reception portion.

2) The display assembly of claim 1 wherein said sign retention portion has a flat member and includes at least one information member which may be selectively secured to said flat surface.

3) The display assembly of claim 2 further comprising a C-shaped flexible member which is removably and frictionally secured to said information member and to said to said flat member.

4) The display assembly of claim 2 further comprising a pin which selectively and removably secures said information member to said flat member.

5) The display assembly of claim 2 wherein sign retention portion has a C-shaped cross sectional area.

6) An advertising assembly comprising a first broad planar portion having a substantially C-shaped cross sectional area of a certain width and a certain height and a second channel portion which orthogonally extends from said first broad planar portion and which includes a through hole having an axis of symmetry which is substantially parallel to said first broad planar portion; a sign member which has a height which is slightly smaller than said certain height and a width which is slightly shorter than said certain width and which is adapted to selectively and frictionally fit upon said first broad planar portion; and a pin which is selectively and removably received within said through hole.

7) The advertising assembly of claim 6 further comprising a flexible C-shaped member which is removably and frictionally secured to said sign member and to said first broad planar portion.

8) The advertising assembly of claim 6 further comprising a pin which selectively secures said sign member to said first broad planar portion.

9) An advertising assembly comprising a support portion having a broad planar sign reception surface having a pair of opposed edges which respectively border said broad planar sign reception portion and are respectively and linearly coextensive to said broad planar sign reception portion, wherein said support portion includes a hitch reception portion which orthogonally emanates from said planar sign reception portion and which has a slightly smaller width than the width of a trailer hitch and which further includes a through hole of a certain diameter; a first pin which has a diameter which is slightly smaller than the certain diameter; and a second C- shaped member which includes a support width which is only slightly larger than the distance between said pair of opposed edges; and a flat information containment member which has a width which is slightly smaller than said distance between said pair of opposed edges.

10) The advertising assembly of claim 9 wherein said flat information containment member is formed from plastic.

11) The advertising assembly of claim 10 wherein said planar sign reception portion is formed from steel.
